(19) United States
(12) Patent Application Publication
(10) Pub. No.: US 2004/0059561 A1
(43) Pub. Date: Mar. 25, 2004

(54) Method and apparatus for determining output uncertainty of computer system models using sensitivity characterization

(76) Inventor: Ilya Gluhovsky, Mountain View, CA (US)

Correspondence Address: ROSENTHAL & OSHA L.L.P. / SUN, 1221 MCKINNEY, SUITE 2800, HOUSTON, TX, 77010, US

(21) Appl. No.: 10/254,205

(22) Filed: Sep. 25, 2002

(51) Int. Cl. G06F 9/45

(52) U.S. Cl. 703/22

(57) ABSTRACT

A method for generating an uncertainty characterization for a system simulation model, including obtaining system simulation input for the system simulation model, generating a sensitivity characterization using the system simulation input, and generating the uncertainty characterization for the system simulation model using the sensitivity characterization.

### BACKGROUND OF INVENTION

Generally, a microprocessor operates much faster than main memory can supply data to the microprocessor. Therefore, many computer systems temporarily store recently and frequently used data in smaller, but much faster, cache memory. Many computers use multi-level cache memory systems, where there are many levels of cache, e.g., level one (L1), level two (L2), level three (L3), etc. L1 cache typically is closest to the microprocessor, smaller in size, and faster in access time. Typically, as the level of the cache increases (e.g., from L1 to L2 to L3), the level of cache is further from the microprocessor, larger in size, slower in access time, and supports more microprocessors.

Cache memory architecture may vary in configuration, such as cache size, cache line size, cache associativity, cache sharing, method of writing data to a cache, etc. Cache size refers to the total size of the cache memory. The cache memory is configured to store data in discrete blocks in the cache memory. A block is the minimum unit of information within each level of cache. The size of the block is referred to as the cache line size. The manner in which data is stored in the blocks is referred to as cache associativity. Cache memories typically use one of the following types of cache associativity: direct mapped (one-to-one), fully associative (one-to-all), or set associative (one-to-set).

Cache sharing refers to the manner in which data in the blocks are shared. Specifically, L1 cache sharing is the number of processors (physical or virtual) sharing the L1 cache, i.e., the number of L1 caches sharing one L2 cache; and the number of L2 caches sharing one L3 cache, etc. Most program instructions involve accessing (reading) data stored in the cache memory; therefore, the cache associativity, cache sharing, cache size, and cache line size are particularly significant to the cache architecture.

Likewise, writing to the cache memory (cache write type) is also critical to cache architecture, because the process of writing is generally a very expensive process in terms of process time. Cache memory generally uses one of the following methods when writing data to the cache memory: “write through, no-write allocate” or “write back, write allocate.”

The performance of the cache architecture is measured using a variety of parameters, including a miss rate (either load or store), a hit rate, an instruction count, an average memory access time, etc. The miss rate is the fraction of all memory accesses that are not satisfied by the cache memory. There are a variety of miss rates, e.g., intervention, clean, total, “write back,” cast out, upgrade, etc. In contrast, the hit rate is the fraction of all memory accesses that are satisfied by the cache memory. The instruction count is the number of instructions processed in a particular amount of time. The average cache access time is the amount of time on average that is required to access data in a block of the cache memory.

Simulation is a useful tool in determining the performance of a particular cache architecture (i.e., a particular cache size, cache line size, cache associativity, etc.). Simulation of a cache memory may be implemented using a computer system. Thus, given a workload trace (a set of sequences of program instructions linked together, which are executed by microprocessors that emulate sets of typical instructions) and the cache architecture, the performance, e.g., hit/miss rates, of the cache architecture may be simulated.

Simulation of the cache architecture typically involves dealing with certain constraints. For example, for a given set of cache architectural components, including a range of possible measurements for each cache architectural component, the number of permutations to fully simulate the cache architecture may be very large, thus introducing a possible constraint upon cache simulation. Also, there are often additional constraints when using simulation. For example, a trace characterizing each level of the number of processors of interest is required. However, some traces may be absent, or short traces that provide realistic scenarios do not sufficiently “warm-up” large cache sizes, i.e., a trace may not be long enough for the simulation to reach steady-state cache rates. In addition, uncertainty in benchmark tuning is another example of constraints in simulation. Additionally, in the interest of time and cost, usually only a small sample set of cache architectures is simulated.

Once the simulation is performed on the small sample set of the cache architecture, statistical analysis is used to estimate the performance of the cache architectures that are not simulated. The quality of the statistical analysis relies on the degree to which the sample sets are representative of the sample space, i.e., permutations for a given set of cache architectural components. Sample sets are generated using probabilistic and non-probabilistic methods. Inferential statistics along with data obtained from the sample set are then used to model the sample space for the given architectural components. Models are typically used to extrapolate using the data obtained from the sample set. The models used are typically univariate or multivariate in nature. The univariate model is analysis of a single variable and is generally useful to describe relevant aspects of data. The multivariate model is analysis of one variable contingent on the measurements of other variables. Further, the models used to fit the data of the sample set may be smoothed models obtained using a plurality of algorithms.

System model simulators are often used in designing computer system architectures. For example, closed queuing networks may be used to create a logical network that models the handling of memory requests made by microprocessors of a multi-processor computer system. A memory request takes a route through the logical network, where the route taken by the memory request is determined in part by inputs to the system model simulator.

FIG. 1 shows the system model simulator (30), which generates a system model output (32) that may be used to predict performance and to help resolve architectural tradeoffs. An input to the system model simulator (30) is workload characteristics, which is generally a cache simulation output (34). The system model simulator (30) also has other inputs (36), which are often fixed, such as cache and memory latencies, or bus widths.

The cache simulation output (34) includes cache operational parameters in the form of rates per instruction for the multi-level cache hierarchy, including a load miss rate, a store miss rate, a load write back rate, and other rate per instruction parameters of the multi-level cache hierarchy. For example, the cache simulation output for a typical cache memory architecture may have a store miss rate of 0.37% and a load miss rate of 0.71%.

Factors such as cache simulation constraints (e.g., benchmark tuning, trace collection, trace warm-up, etc.) may introduce uncertainties into the cache simulation output (34). For example, traces for simulating different set of inputs for different configurations (e.g., for different numbers of microprocessors or for different cache sizes) are often collected by different experts in potentially different settings. The system model output (32) may be affected by such input uncertainties, i.e., uncertainties included in the cache simulation output (34).

### SUMMARY OF THE INVENTION

In general, in one aspect, the invention relates to a method for generating an uncertainty characterization for a system simulation model, comprising obtaining system simulation input for the system simulation model, generating a sensitivity characterization using the system simulation input, and generating the uncertainty characterization for the system simulation model using the sensitivity characterization.

In general, in one aspect, the invention relates to a computer system for generating an uncertainty characterization for a system simulation model, comprising a processor, a memory, a storage device, and software instructions stored in the memory for enabling the computer system, under the control of the processor, to perform obtaining system simulation input for the system simulation model, generating a sensitivity characterization using the system simulation input, and generating the uncertainty characterization for the system simulation model using the sensitivity characterization.

In general, in one aspect, the invention relates to an apparatus for generating an uncertainty characterization for a system simulation model, comprising means for obtaining system simulation input for the system simulation model, means for generating a sensitivity characterization using the system simulation input, and means for generating the uncertainty characterization for the system simulation model using the sensitivity characterization.

Other aspects and advantages of the invention will be apparent from the following description and the appended claims.

### BRIEF DESCRIPTION OF DRAWINGS

FIG. 1 illustrates a flow diagram for a typical system model simulator.

FIG. 2 illustrates a typical computer system.

FIG. 3 illustrates a flow chart for generating an uncertainty characterization for a system simulation model in accordance with one embodiment of the invention.

### DETAILED DESCRIPTION

Exemplary embodiments of the invention will be described with reference to the accompanying drawings. Like items in the drawings are denoted by the same reference numbers throughout the figures for consistency.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

The invention relates to a method for generating an uncertainty characterization for a system simulation model. Further, the invention relates to generating the uncertainty model using a sensitivity characterization.

For system simulation models to aid a computer designer in predicting performance and resolving architectural tradeoffs for various system configurations, the computer designer should have an understanding of the accuracy of the system simulation model. Typically, because the system simulation model uses outputs (e.g., a cache simulation output) from other models as inputs, it is useful to understand and characterize the uncertainty resulting from such inputs.

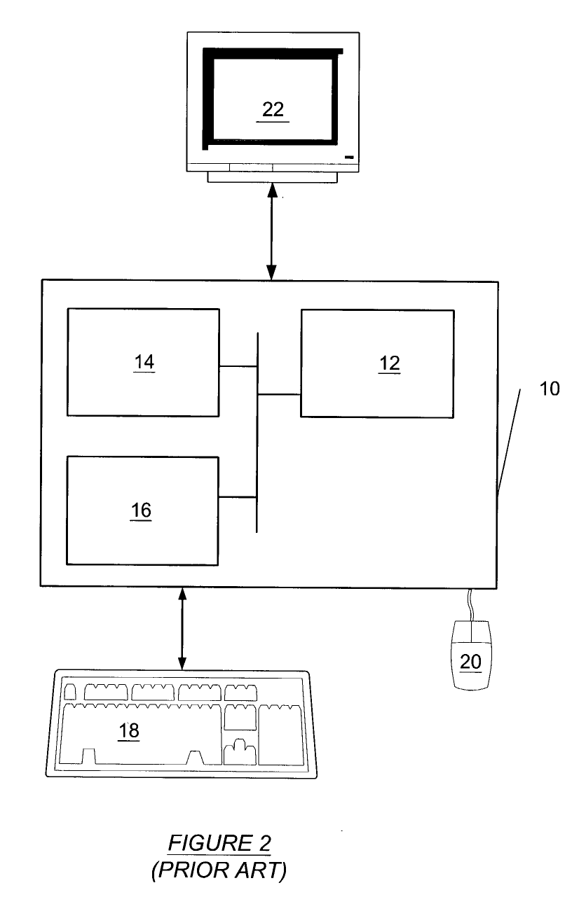

The invention may be implemented on virtually any type computer regardless of the platform being used. For example, as shown in FIG. 2, a typical computer (10) includes a processor (12), associated memory (14), a storage device (16), and numerous other elements and functionalities typical of today's computers (not shown). The computer (10) may also include input means, such as a keyboard (18) and a mouse (20), and output means, such as a monitor (22).

Those skilled in the art will appreciate that these input and output means may take other forms in an accessible environment.

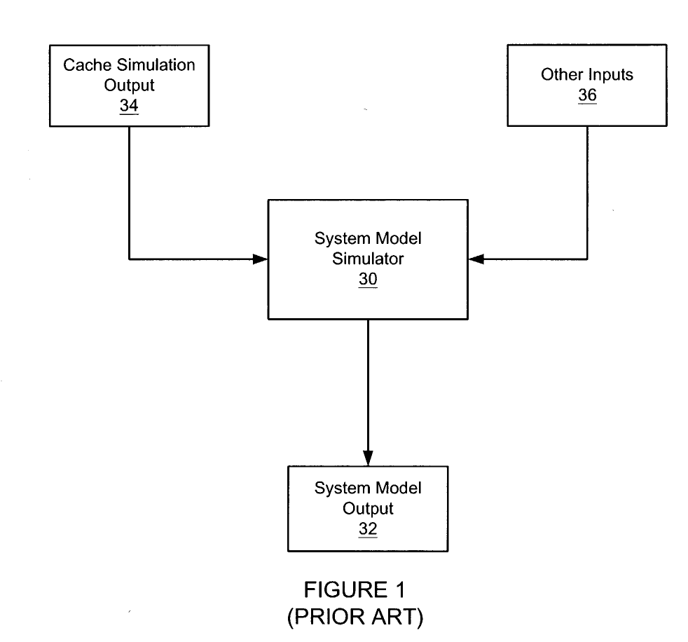

A system simulation model (f) defines how a particular system operates with respect to a set of input parameters (e.g., miss rate per instruction, writeback rate per instruction, etc.). The result of running a system simulation model (f) with a particular set of inputs is to obtain a set of outputs that describes performance parameters (e.g., cycles per second to execution of a particular function, number of transactions a second, etc.). The input set typically includes, but is not limited to, cache simulation output (34 in FIG. 1), hardware characteristic input (36 in FIG. 1), etc. The input set corresponds to a particular input configuration, where each input configuration may be denoted by a vector (x). The vector includes the necessary parameters (i.e., Xₚ) that the system simulation model requires to generate system model output (32 in FIG. 1).

For example, the vector may include the miss rate, the writeback rate, and the upgrade rate per instruction for each level of cache for a particular cache configuration. The values for the various parameters in the vector are typically generated by inputting the necessary system configuration parameters into a model and obtaining the value for the parameter. For example, to obtain values corresponding to the multilevel cache hierarchy performance parameters (i.e., miss rate per instruction, upgrade rate per instruction, etc.), a cache architecture parameter is input into the workload characterization model to obtain the corresponding multilevel cache hierarchy performance parameters.

To determine the uncertainty associated with each performance parameter, i.e., the sensitivity of a particular performance parameter to particular parameters in the input set, the posterior distribution for each input parameter and the sensitivity for each input parameter are used. The posterior distribution represents the probability of a result in view of uncertainty about information used to obtain the result.

The posterior distribution may be defined by the following equation:

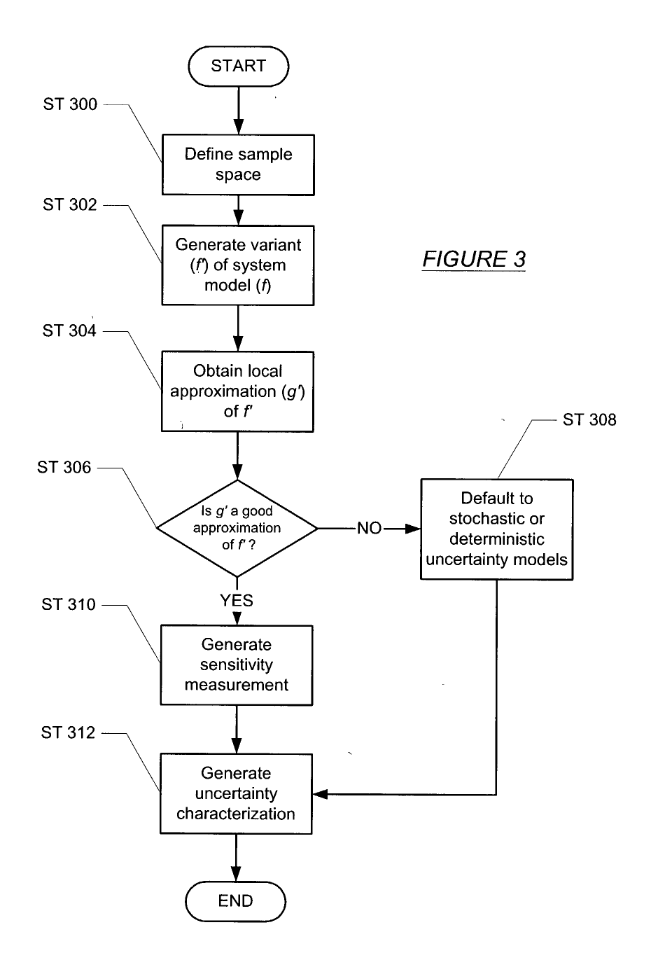

gₚ(Xₚ)≈indN(Xₚ^{m},σₚ²) (1)

where, gₚ is the measurement scale (e.g., a log scale) on which Xₚ is has an independent (“ind”) normal (“No”) posterior distribution, Xₚ denotes the actual unknown values of the input parameters, Xₚ^{m} denotes the measured values of the input parameters, and σₚ² denotes the variance associated with input parameter p. FIG. 3 illustrates a flow chart for generating an uncertainty characterization for a system simulation model in accordance with one embodiment of the invention. Initially, a sample space is defined (Step 300). In one embodiment of the invention, the sample space may be defined using a bump-hunting technique.

Returning to FIG. 3, a variant (f′) of the system model (f) is then generated such that the variant (f′) is locally linear and globally defined, with the extent of locality determined by the variance structure of the system model inputs (Step 302). The following equations illustrate how the variant (f′) of the system model (f) is obtained.

x′=g(x) (3)

f(x′)=f(g′(x′)) (4)

where x′ denotes a set of input vectors obtained from the posterior distribution, g represents a measurement scale and g⁻¹ denotes the inverse of g, f denotes the system model, and f′ denotes the variant of the system model.

Once f′ is obtained, g′ a local linear approximation of f′ for each point in the sample space, is obtained (Step 304). In one embodiment of the invention, a linear multivariate modeling technique is used to obtain the local linear approximation (g′) for each point. After the local linear approximation (g′) is obtained for each point, whether the local linear approximation (g′) for each point is a good approximation of the variant f′ of the system model (f) is verified (Step 306).

Those skilled in the art will appreciate that if the number of points in the sample space is sufficiently larger than can be modeled using sample space of interest may be decreased by using a multivariate modeling technique or a bump hunting technique. In the multivariate modeling technique, a representative subset of points is derived from the total number of points in the sample space. The subset of points is analyzed in accordance with the invention, and the results of the analysis are used to generate a model that defines the entire sample space.

Alternatively, the bump-hunting technique, as described above, may be used to decrease the number of point in the sample space to be analyzed by determining which inputs have a significant impact on the uncertainty and choosing points in the sample space accordingly.

In one embodiment of the invention, a smooth function (\tilde{f}′) is generated to model the variant (f′) of the system model (f) over the sample space. The following formula is then used to verify whether the local linear approximation (g′) for each point is a good approximation of the variant f′ of the system model (f) over the corresponding region (U).

$$Δ = \sqrt{\frac{{\int }_{U} {( {\tilde{f}}^{′} ( {\underline{x}}^{′} ) - {g}^{′} ( {\underline{x}}^{′} ) )}^{2}}{\vert U \vert}} , \qquad ( 5 )$$

where Δ represents the normalized square-toot residual sum of squares between \tilde{f}′ and g′ over the region over which g′ is defined (U). In one embodiment of the invention, Δ may be compared to an absolute threshold value (e.g., Δₒ) such that Δ must be less than or equal to Δₒ for the local linear approximation (g′) for each point to be a good approximation of the variant f′ of the system model (f) over the corresponding region (U). Alternatively, Δ may be compared to a percent deviation of the average value of \tilde{f}′ over U, e.g., Δ≦δₒ\tilde{f}′, to verify if local linear approximation (g′) for each point is a good approximation of the variant f′ of the system model (f) over the corresponding region (U).

Those skilled in the art will appreciate that the number of data points typically required to fit a smooth model (i.e., \tilde{f}′) with the same level of accuracy as a linear model (i.e., g′) is larger. Thus, either additional sampling is conducted to obtained additional data points or the amount of smoothness in the smooth model (i.e., \tilde{f}′). In the latter case \tilde{f}′ may not approximate f′ well, and/or the approximation error (i.e., Δ) may be underestimated. In these instances, one may take into account degrees of freedom (dj) associated with \tilde{f}′. Since \tilde{f}′ in these cases is undersmoothed due to the restriction of data points, the approximation error (i.e., Δ) between g′ and \tilde{f}′ is expected to increase with an increase in df of \tilde{f}′. Thus, similar to a stochastic situation with independent noise one can use the following equation to determine if g′ is a good approximation of the variant of the system model (f′):

Δ²≦Δ²_{O}F_{α,df-3,n-df}, (6)

where Δ²_{O} is variance estimate, and F_{α,df-3,n-df} is the appropriate cut-off with an F distribution. If variance is known, then F_{α,df-3,n-df} may be replaced by χ²_{α,df-3}.

Returning to FIG. 3, if the local linear approximation (g′) for each point is not a good approximation of the variant f′ of the system model (f) over the corresponding region (U), as defined by the tests above, then one may use a stochastic uncertainty model or a deterministic uncertainty model (Step 308), as disclosed in U.S. Patent Application Ser. No. ______ filed ______, entitled “Method and Apparatus for Determining Output Uncertainty of Computer System Models,” in the name of Ilya Gluhovsky. In this case, where the stochastic model or the deterministic model, is generated (Step 308), then the stochastic model, or the deterministic model is used to generate the uncertainty characterization (Step 312). The uncertainty characterization defines the accuracy of the system simulation model. Further, the uncertainty characterization also indicates the amount of uncertainty a particular input introduces to the system model output (i.e., 32 in FIG. 1).

Returning to FIG. 3, if the local linear approximation (g′) is a good approximation of the variant f′ of the system model (f), as defined by the tests above, then the local linear approximation (g′) for each point is used to generate the sensitivity measurement. In one embodiment of the invention, the sensitivity measurement (s) is defined as the partial derivative with respect to a particular parameter at x′. Thus, the sensitivity (s) for a particular parameter (p) may be defined as follows:

sₚ(x′)=∂f′/∂x′ₚ, (7)

where sₚ is the sensitivity with respect to parameter p, f′ is the variant of the system model (f), and x′ₚ corresponds to the measurements of x′ₚ corresponding to parameter p. If g′ is a good linear approximation of f′, then the sensitivity (sₚ) may be estimated by the coefficients of g′.

Returning to FIG. 3, the sensitivity measurements generated in Step 310 are then used to generate the uncertainty characterization. The uncertainty characterization defines the accuracy of the system simulation model. Further, the uncertainty characterization also indicates the amount of uncertainty a particular input introduces to the system model output (i.e., 32 in FIG. 1). Those skilled in the art will appreciate that in the case where there are many sample spaces, the sensitivity measurements obtained for each of the sample spaces may be used to generate an uncertainty model over the entire sample space. In one embodiment of the invention, a multivariate smoother is used to generate the uncertainty model over the entire sample space.

In one embodiment of the invention, the uncertainty characterization is generated by obtaining a set of points (e.g., an experimentation set) from the sample space and applying the partial derivative, with respect to the parameters of interest, for each of the plurality of linear approximations to the experimentation set. The result is the uncertainty characterization. The aforementioned process for generating the uncertainty characterization is summarized by the following equation:

$$ξ = \sqrt{{\sum }_{p} {s}_{p}^{2} {σ}_{p}^{2}} , \qquad ( 8 )$$

where ξ denotes the overall uncertainty measure, σₚ² denotes the variance with respect to p, and sₚ² denotes the sensitivity with respect to p. The uncertainty characterization is subsequently used to obtain an understanding of the effect of the inputs, specifically the uncertainty, on the resulting outputs.

In certain cases one may wish to look at only a particular set of inputs or a particular region within the sample space, i.e., a region of interest. In one embodiment of the invention, the region of interest may be obtained using an objective function, such as the following objective function (h):

$$h = {\sum }_{p = n - 2}^{n} {( {s}^{2} {σ}^{2} )}_{( p )} - {\sum }_{r = 1}^{n - 3} {( {s}^{2} {σ}^{2} )}_{( r )} \qquad ( 2 )$$

where (s²σ²)₍ₚ₎ corresponds to the variance of the p^{th} order statistic of sₚ²σₚ², and (s²σ²)₍ᵣ₎ corresponds to the variance of the rest of the statistics. The objective function (h) compares the variance due to the three most varying inputs to variance of the rest of the inputs. Thus, regions that have a large value of h are the regions of interest. Because the sensitivity (s) is unknown, bump hunting procedures may used to obtain interpretable estimates of (s²σ²)₍ₚ₎ and (s²σ²)₍ᵣ₎.

In one embodiment of the invention, one may wish to model the entire input space using the invention described above. Initially, a sparse set of inputs representing the entire input space is drawn from the sample space. The sparse set of inputs may be obtained using an experimental design technique. Once the sparse set of inputs has been obtained, the sensitivity measurement, described above, may be used to generate an uncertainty model for each of the inputs in the sparse set of inputs. A multivariate fitting routine may then be applied to the uncertainty models to generate a surface that describes the uncertainty. Further, a threshold may be applied to the surface to identify regions of high uncertainty. Alternatively, a bump-hunting technique may be applied to the uncertainty models to determine regions of high uncertainty. As noted above the regions of high uncertainty correspond, at least in part, to the uncertainty characterization described above.

Embodiments of the invention may have one or more of the following advantages. The invention provides a computer designer a means to generate a certainty characterization for the system simulation model that may be subsequently used to design a system architecture. The invention presents a way to determine an interval that covers the true performance measure with specified confidence (e.g., 95%). Thus, a computer designer knows the reliability of the performance estimates. The invention provides a description of how input uncertainty translates into output uncertainty provides an indication of how accurately the inputs need to be measured to obtain reliable outputs (performance estimates). The invention determines the relative importance of accurate estimation within different regions (e.g., regions with higher miss rates have larger associated output uncertainty). The invention determines those regions in the input space where more accurate estimation of one input or another would have a significant effect on the confidence in the accuracy of the outputs. Thus, if it is possible to obtain more precise measurements by allocating scarce resources (e.g., collect additional traces using a different collection procedure and re-simulate caches), more measurements should be made in those regions.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for generating an uncertainty characterization for a system simulation model, comprising:
obtaining system simulation input for the system simulation model;
generating a sensitivity characterization using the system simulation input; and
generating the uncertainty characterization for the system simulation model using the sensitivity characterization.

2. The method of claim 1, wherein generating sensitivity characterization comprises:
define a sample space;
generating a variant of the system simulation model;
obtaining a local linear approximation of the variant of the system for each of a plurality of points in the sample space; and
generating the sensitivity for each of a plurality of parameters in the local linear approximation using each of the plurality of the local linear approximations of the variant of the system model.

3. The method of claim 2, wherein generating the sensitivity comprises:
determining a partial derivative for each of the plurality of linear approximations with respect to each of the plurality of parameters in the plurality of local linear approximations;
obtaining an experimentation set from the system simulation input, wherein the experimentation set is obtained using an independent sampling technique; and
applying the plurality of partial derivatives to the experimentation set to obtain the uncertainty characterization.

4. The method of claim 2, wherein generating the sensitivity characterization further comprises:
generating a smooth variant of the system model; and
generating a new local linear approximation of the variant of the system model for at least one the plurality of points if the average approximation error between the smooth variant model and the local linear approximation of the variant of the system model for the at least one of the plurality of points is greater then a threshold value.

5. The method of claim 1, wherein generating the uncertainty characterization comprises:
obtaining a normal posterior distribution.

6. The method of claim 5, wherein the normal distribution is defined on a log scale.

7. The method of claim 2, wherein determining of the sample space comprises using a bump-hunting technique.

8. The method of claim 2, wherein a region of interest within the sample is determined using an objective function.

9. A computer system for generating an uncertainty characterization for a system simulation model, comprising:
a processor;
a memory;
a storage device; and
software instructions stored in the memory for enabling the computer system, under the control of the processor, to perform:
obtaining system simulation input for the system simulation model;
generating a sensitivity characterization using the system simulation input; and
generating the uncertainty characterization for the system simulation model using the sensitivity characterization.

10. The computer system of claim 9, wherein generating sensitivity characterization comprises:
defining a sample space;
generating a variant of the system simulation model;
obtaining a local linear approximation of the variant of the system for each of a plurality of points in the sample space; and
generating the sensitivity for each of a plurality of parameters in the local linear approximation using each of the plurality of the local linear approximations of the variant of the system model.

11. The computer system of claim 10, wherein generating the sensitivity comprises:
determining a partial derivative for each of the plurality of linear approximations with respect to each of the plurality of parameters in the plurality of local linear approximations;
obtaining an experimentation set from the system simulation input, wherein the experimentation set is obtained using an independent sampling technique; and
applying the plurality of partial derivatives to the experimentation set to obtain the uncertainty characterization.

12. The computer system of claim 10, wherein generating the sensitivity characterization further comprises:
generating a smooth variant of the system model; and
generating a new local linear approximation of the variant of the system model for at least one the plurality of points if the average approximation error between the smooth variant model and the local linear approximation of the variant of the system model for the at least one of the plurality of points is greater then a threshold value.

13. The computer system of claim 9, wherein generating the uncertainty characterization comprises:
obtaining a normal posterior distribution.

14. The computer system of claim 13, wherein the normal distribution is defined on a log scale.

15. The computer system of claim 10, wherein determining of the sample space comprises using a bump-hunting technique.

16. The computer system of claim 10, wherein a region of interest within the sample is determined using an objective function.

17. An apparatus for generating an uncertainty characterization for a system simulation model, comprising:
means for obtaining system simulation input for the system simulation model;
means for generating a sensitivity characterization using the system simulation input; and
means for generating the uncertainty characterization for the system simulation model using the sensitivity characterization.

18. The apparatus of claim 17, wherein means for generating sensitivity characterization comprises:
means for defining the sample space;
means for generating a variant of the system simulation model;
means for obtaining a local linear approximation of the variant of the system for each of a plurality of points in the sample space; and
means for generating the sensitivity for each of a plurality of parameters in the local linear approximation using each of the plurality of the local linear approximations of the variant of the system model.

19. The apparatus of claim 17, wherein generating the sensitivity comprises:
means for determining a partial derivative for each of the plurality of linear approximations with respect to each of the plurality of parameters in the plurality of local linear approximations;
means for obtaining an experimentation set from the system simulation input, wherein the experimentation set is obtained using an independent sampling technique; and
means for applying the plurality of partial derivatives to the experimentation set to obtain the uncertainty characterization.
